(19) United States
(12) Patent Application Publication
(10) Pub. No.: US 2024/0010136 A1
(43) Pub. Date: Jan. 11, 2024

(54) Ramp for Bicycle Carrier

(71) Applicant: Kuat Innovations LLC, Springfield, MO (US)

(72) Inventor: Luke Kuschmeader, Springfield, MO (US)

(73) Assignee: Kuat Innovations LLC, Springfield, MO (US)

(21) Appl. No.: 18/348,386

(22) Filed: Jul. 7, 2023

Related U.S. Application Data
(60) Provisional application No. 63/367,951, filed on Jul. 8, 2022.

(51) Int. Cl. B60R 9/10

(52) U.S. Cl. CPC B60R 9/10

(57) ABSTRACT

A ramp for use and integration with bicycle carriers for automobiles. The integrated ramp allows a user to roll a bicycle onto the bicycle carrier without using a separate ramp. The integrated ramp may include one or more integrated or removable ramp components that attach to a wheel securement arm of the bicycle carrier. The ramp components may include a ramp portion that folds or moves from a stowed position to a deployed position. In the stowed position the ramp portion does not interfere with the use of the wheel securement arm of the bicycle carrier to hold a bicycle on the carrier. In the deployed position the ramp portion serves as a ramp for rolling a bicycle onto the carrier.

### CROSS-REFERENCE TO RELATED APPLICATIONS

This application claims the benefit of the filing date of U.S. Provisional Patent Application No. 63/367,951 filed on Jul. 8, 2022.

### BACKGROUND

### Field of the Invention

This disclosure is in the field of carriers for carrying bicycles on automobiles. More specifically, this disclosure is in the field of bicycle carriers designed to carry bicycles on a platform. Further, this disclosure is in the field of ramps for loading bicycles onto a platform-style bicycle carrier.

### SUMMARY OF THE INVENTION

In various embodiments, the inventive bicycle carrier comprises folding tabs attached to the wheel securement arm of the bicycle carrier. In a stowed configuration the folding tabs allow the wheel securement arm to hold a bicycle on the carrier. In a deployed configuration the folding tabs allow the wheel securement arm to be used as a ramp to roll a bicycle onto the carrier or roll a bicycle off the carrier.

In other embodiments, the invention comprises ramp components for attachment to the tire securement arm of a bicycle carrier to configure the tire securement arm for use as a ramp for loading and unloading a bicycle from the bicycle carrier.

### BRIEF DESCRIPTION OF THE DRAWINGS

FIG. 1 is a perspective view of a bicycle rack incorporating an embodiment of the bicycle ramp component.

FIG. 2 is a perspective view of a bicycle rack incorporating an embodiment of the bicycle ramp component.

FIG. 3 is a perspective view of a portion of a bicycle rack incorporating an embodiment of the bicycle ramp component.

FIG. 4 is an end plan view of an embodiment of the bicycle ramp component in a stowed configuration.

FIG. 5 is a perspective view of an embodiment of the bicycle ramp component in a stowed configuration.

FIG. 6 is an end view of an embodiment of the bicycle ramp component in a deployed configuration.

FIG. 7 is an end plan view of an embodiment of the bicycle ramp component in a deployed configuration.

FIG. 8 is a perspective view of an embodiment of the bicycle ramp component in a deployed configuration.

### DETAILED DESCRIPTION

Bicycles may be carried on a vehicle by using a bicycle rack or carrier provided with platforms to support the tires of the bicycle. In some of these types of platform bicycle racks, tire or wheel securement arms are used to secure the tire or wheel of the bicycle on the platform during movement of the vehicle. In such bicycle carriers a user typically opens one or more such wheel securement arms to an extended position, lifts a bicycle and sets it on the platform, and then closes one or more wheel securement arms until the arms contact the bicycle or the bicycle tire to hold the bicycle in place on the carrier.

In some cases, a user may be unable to lift their bicycle onto the carrier. This may be because the bicycle is heavy due to its size or features (such as the electric motor and batteries of an e-bike) or for other reasons. Ramps are available for some bicycle carriers that allow a user to roll a bicycle up the ramp onto the platform. These ramps are typically narrow sheets of metal or other similarly rigid material that lean against the bicycle carrier providing an angled slope up which a bicycle may roll. While the ramps serve their immediate purpose of allowing a user to roll a bicycle onto the carrier, they are bulky and inconvenient. They typically must be placed inside the vehicle when not in use, taking up storage space, secured to the bicycle carrier in some way. They may easily be forgotten or lost, potentially preventing use of the carrier by a user who is physically unable to lift their bicycle onto or off of the carrier.

The inventive ramp components described herein provide a simple ramp solution that may, in some embodiments, be integrated into a bicycle carrier and remain on the carrier while it is used to transport bicycles on the vehicle. In other embodiments the ramp components may be attached and detached from the bicycle carrier as needed and stored in a very small space within a vehicle.

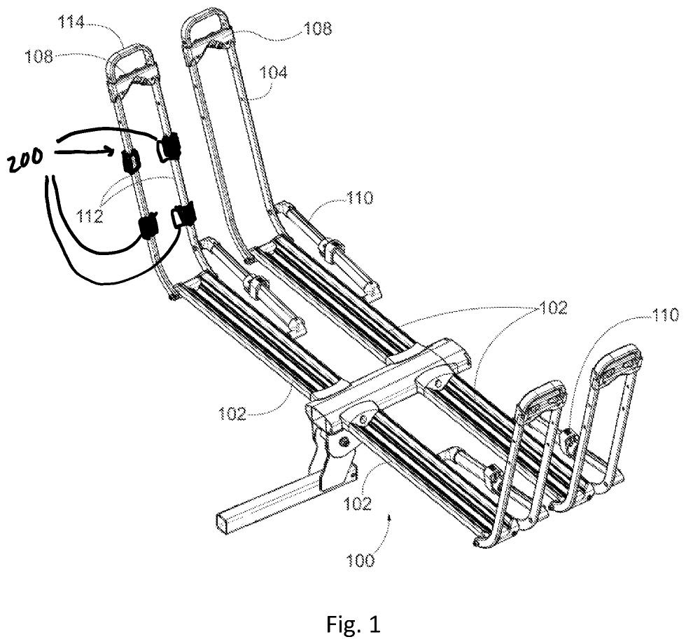

Referring now to FIG. 1, an example of a platform bicycle carrier 100 is depicted. The bicycle carrier 100 is designed for attachment to a vehicle and provided with several platforms 102 for receiving bicycle tires. The wheel securement arms 104 may be rotated inwardly against the tires of the bicycle to secure the bicycle in place on the platform. In the depicted carrier, one wheel securement arm 104 has several embodiments of the inventive ramp component attached to the side members 112 of the wheel securement arm 104. In this figure, the ramp components 200 are shown in a closed or stowed configuration. In the depiction there are four separate ramp components on the wheel securement arm 104, though in various implementations there may be more or fewer of the ramp components 200.

The ramp components 200 may also be disposed on the wheel securement arm 104 in different configurations. For example, the ramp components 200 may be staggered so that they are not directly across from another component 200 on the other arm member 112. They may also be closer together, more spaced out, or grouped at specific points along the length of the arm 104. In some embodiments they may all be on the same arm member 112.

In the depicted embodiment, when the ramp components 200 are in the closed or stowed position, they do not contact the bicycle wheel while it is stored on the bicycle carrier, or if they do then the contact is incidental and not necessary for the use of the carrier. In other embodiments the ramp components 200 may comprise part of the mechanism of securing the tire of a bicycle on the carrier 100.

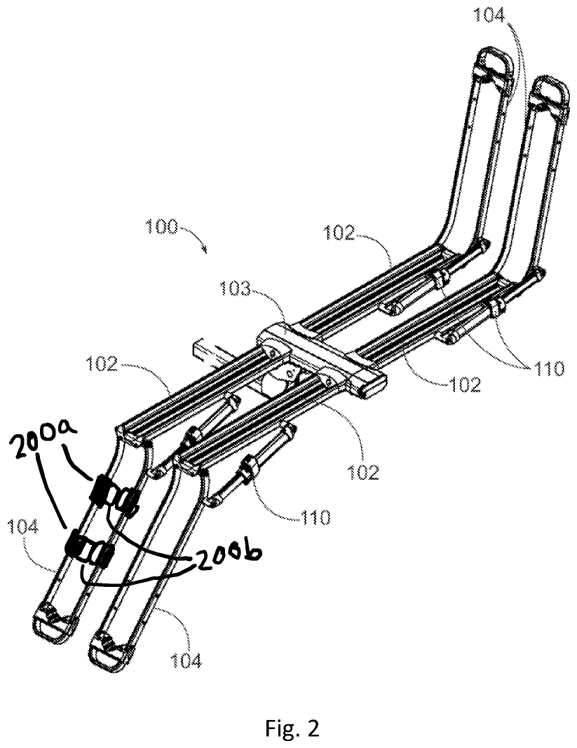

FIG. 2 depicts a bicycle carrier in which two of the wheel securement arms 104 have been rotated outwardly until they pass below the level of the platforms 102. In this “over center” configuration a separate ramp could be placed in contact with the platform 102 and the ground, as in some prior art products. However, in one of the depicted wheel securement arms 104, four ramp components 200 have been attached to the wheel securement arm 104. Portions of the ramp components 200 have been reconfigured (in this case pivoted) from a stowed position to a deployed configuration in which they span all or a portion of the distance between the two arm members 112, either singly or in combination with another ramp component 200. The deployed portions of the ramp components 200 provide a surface on which a bicycle tire may be rolled upwardly onto the platform.

The ramp components need not provide a continuous surface along the length of the arm 104 to provide useful support to a user loading a bicycle onto the rack 100. In FIG. 2 the ramp components 200 are disposed in pairs on opposite sides of the wheel securement arm 114. These pairs are aligned on the side members 114.

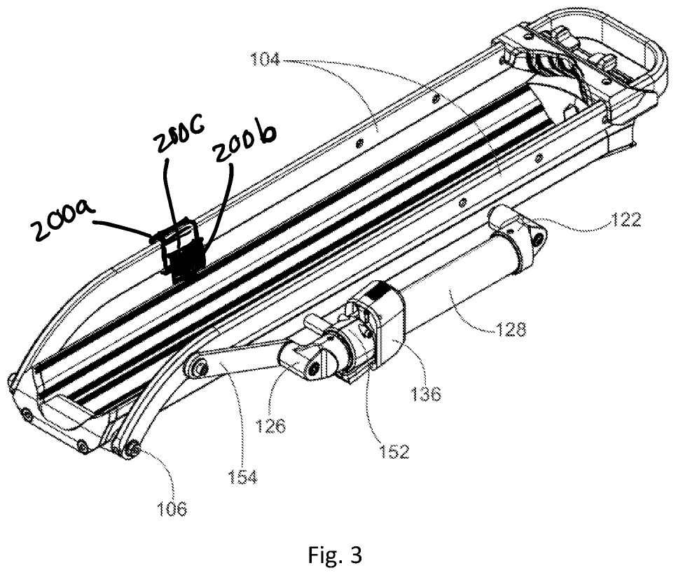

FIG. 3 depicts a portion of a rack 100 with the arm 104 in a closed position. The ramp component 200 is shown in a stowed position. In this embodiment the stowed configuration comprises the ramp portion 200b pivoted adjacent to the bracket 200a around hinge 200c. In the deployed configuration of this embodiment the ramp portion 200b extends substantially perpendicular to the bracket portion 200a.

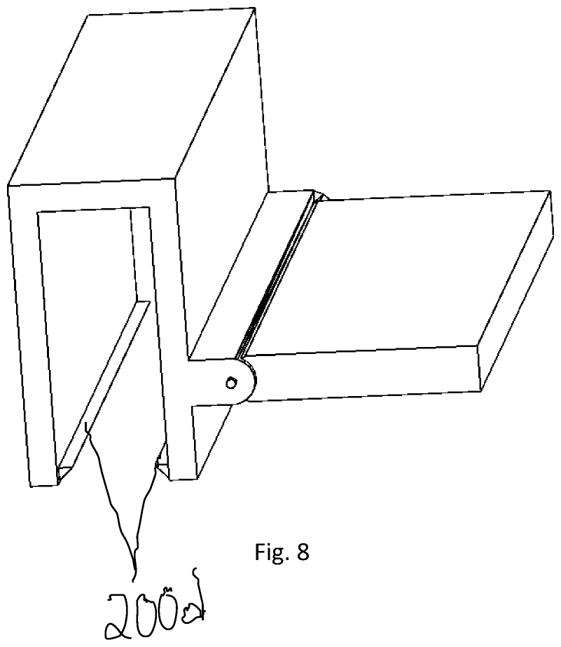

In the depicted embodiments the ramp components 200 comprise a bracket 200a for attaching the component 200 to a side arm 114 of a tire securing arm 104. In various embodiments, the bracket 200a may be formed as part of the side member 104 or it may be attached to the side member 114 by fastening means such as screws, bolts, levers, clamps, or other similar fasteners, or held in place by friction or compressive forces. In some embodiments, the bracket 200a may “snap fit” over the side member 114 with a flange 200e as shown in FIG. 8. In some embodiments, the component 200 may be attached and detached from the side member 114 without tools. Some embodiments of the bracket 200a may be able to slide up and down the side member 114 to allow a user to vary its position for optimal use as a ramp or to move it out of the way when not in use.

In FIG. 2 the ramp tab portion 200b extends transversely to the wheel securement arm in the deployed position. In this transverse orientation the tabs 200b extend across the gap between side arms 114. In a wheel securement arm with only one side member 114 the tabs 200b are transverse to the longitudinal axis (the longest dimension) of platform 102 when deployed.

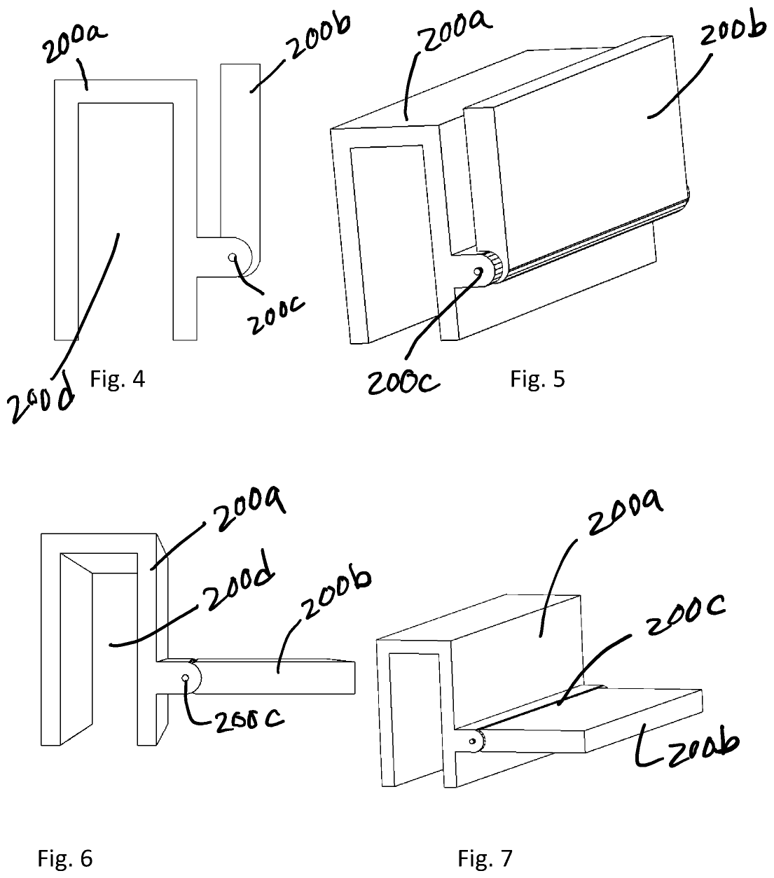

Referring to FIGS. 4 and 5, an embodiment of the ramp component 200 is depicted in a stowed configuration. In this embodiment the bracket 200a is designed to snap over the arm member 114 of a rack 100. The bracket 200a maybe formed of a semi-rigid material such as a plastic material that is sufficiently flexibly so that the aperture along one edge of the bracket can widen sufficiently to pass around arm member 114. The arm member 114 is then captured in aperture or cavity 200d. In some embodiments a flange 200e shown in FIG. 8 may engage an edge or feature of the arm member 114 to hold the ramp component 200 in place. The ramp component tab 200b is shown folded against the side of bracket 200a along hinge 200c.

In FIGS. 6 and 7, an embodiment of the ramp component 200 is depicted in a deployed configuration. In these figures the ramp tab portion 200b has been rotated around hinge 200c, in in a downward direction. In varying embodiments, the direction of pivoting may be selected based upon which direction the tire will be addressing the deployed ramp portion 200b so that the ramp portion may only permit a 90-degree rotation between deployed and stowed configurations. In the deployed configuration, tab 200b will not rotate further under the weight of a bicycle as it rolls across the tab.

The depicted embodiment of the ramp component 200 includes a ramp member or tab 200b that is movably attached to the bracket 200a. In the depicted embodiment, the tab 200b is attached to bracket 200a by a hinge 200c. In some embodiments, the ramp member 200b may be directly attached to a hinge or attachment 200c integrated into or directly attached to the side member 114 of the arm 104. In the depicted embodiment in stowed position, the ramp member 200b does not contact a tire secured by the tire securing arm, or the contact is incidental. In the deployed position the ramp member 200b extends outwardly from the tire securing arm 104 sufficiently to serve as a ramp for the tire of a bicycle being loaded on the rack 100.

In some embodiments of the ramp, the arm 104 on which the ramp components 200 are attached may not be used to secure the bicycle or its tire on the rack. The sole purpose of the arm and ramp components in such embodiments may be to provide a folding, integrated ramp for use with the bicycle rack. In other embodiments the arm 104 may not be used to secure the bicycle tire but instead contacts the bicycle frame to hold the bicycle on the rack. In some embodiments the arm 104 may have a single member 112 instead of the two members 112 in the arms 104 depicted in the figures.

In some embodiments the deployed ramp components 200 may not span the entire space between arm members 112, or in the case where there is only one arm member 112, they may not span the width of platform 102. In some embodiments the deployed ramp components provide a surface that is less than the width of a tire of a bicycle to be rolled up the ramp.

In some embodiments, the ramp components are disposed on opposite sides of the arm 104 and in the deployed configuration a bicycle tire will contact both such ramp components as it rolls on arm 104. In some of these embodiments there is a gap between the deployed ramp components 200 that is narrower than the bicycle tire. In other embodiments the deployed ramp components 200 may touch or overlap.

In the depicted embodiments the ramp components on each arm member 114 are separated from each other along the length of the arm 114. In other embodiments the ramp components may be closer together or farther apart as needed to accommodate different sizes of tires. In some methods of using the ramp components they may be slid or otherwise moved along the length of the arm member 114 to allow for use with different size tires.

In some embodiments each ramp component may extend further along the length of arm member 114 than those shown in the figures. In some embodiments the ramp component 200 may extend along more than half or three quarters of the length of arm member 114, and in others it may extend substantially along the entire length of arm member 114. In some embodiments a single ramp component 200 may be sufficient to provide ramp functionality, while in other embodiments a plurality of ramp components 200 may be used on each arm 104 to provide ramp functionality. In some embodiments the ramp component 200 may also provide other functions such as serving as a tire chock. In some embodiments the ramp functionality may be provided by a combination of a tire chock 108 and one or more ramp components 200. In some embodiments a portion of arm 104 such as cross member 114 may also serve as a portion of the ramp.

In some embodiments the ramp component 200 may comprise only the ramp portion 200b. In these embodiments an protrusion, channel, or other attachment feature may be provided on the arm member 114 to accept and hold the ramp component 200 in the desired position. In such embodiments the ramp portion 200b may have a channel instead of or in addition to hinge 200c, and the channel may be shaped to engage a key provided on arm member 114. For example, arm member 114 may have a dovetail-shaped key/protrusion integrated into it at positions for ramp component 200. In such embodiments the ramp portion 200b or hinge 200c may have a dovetail-shaped channel for slidably receiving the key on the arm member 114. In this embodiment, one or more ramp portions 200b may be attached to the arm member 114 only during the time needed to serve as a ramp, and then removed once the bicycle is loaded or unloaded from the rack 100.

In an embodiment of a method of using the ramp components, the following steps may be performed by a user. One or more ramp components 200 may be attached to the arm member 114 of a bicycle rack 100. The ramp components may be in the stowed position until used as a ramp. The user then reconfigures the ramp components 200 to the deployed position, either before or after moving the arm member 114 to a ramp position such as shown in FIG. 2. The user loads a bicycle onto the rack 100 by rolling the tires on the ramp portion 200b of the ramp component 200. The user then secures the bicycle on the rack using the arm member 114, either before or after reconfiguring the ramp components to the stowed position.

The embodiments depicted in FIGS. 4 and 5 comprise a first side wall 400, a second side wall 402, and an end wall 404, that form a cavity 200d. In this embodiment the cavity 200d receives a side member 114 of a wheel securement arm 104.

“Substantially”, “approximately”, or “about” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

Aspects of the present disclosure are described in detail with reference to aspects thereof as illustrated in the accompanying drawings. References to “one aspect,” “an aspect,” “some aspects,” “an embodiment,” “varying embodiments,” etc., indicate that the aspect(s) described may include a particular feature, structure, or characteristic, but every aspect or embodiment may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

1. A bicycle carrier with a ramp comprising:
a wheel securement arm configured to secure a bicycle on the carrier,
a ramp mechanism disposed on the wheel securement arm comprising:
a ramp bracket configured to attach to the wheel securement arm; and
a tab pivotally attached to the ramp bracket by a hinge, the tab configured to pivot from a stowed position to a deployed position;
wherein in the deployed position the tab is configured to function as a ramp for a bicycle during loading on the bicycle carrier.

2. The bicycle carrier with a ramp of claim 1 wherein the ramp bracket is slidably attached to the wheel securement arm of the bicycle carrier.

3. The bicycle carrier with a ramp of claim 1 wherein the tab extends transversely to the wheel securement arm in the deployed position.

4. The bicycle carrier of claim 1 wherein the wheel securement arm comprises a first and a second side member; and the ramp bracket is attached to the first side member.

5. The bicycle carrier of claim 4 further comprising:
a second ramp mechanism comprising a second ramp bracket and a second tab pivotally attached to the second ramp bracket;
wherein the second ramp bracket is attracted to the second side member.

6. The bicycle carrier of claim 5 wherein the ramp bracket and the second ramp bracket are aligned on opposite sides of the wheel securement arm.

7. The bicycle carrier of claim 5 wherein the ramp bracket and the second ramp bracket are staggered on opposite sides of the wheel securement arm.

8. The bicycle carrier of claim 6 wherein in the deployed position the tabs substantially span a transverse width of the wheel securement arm.

9. The bicycle carrier of claim 8 wherein the tabs span at least 75% of the transverse width of the wheel securement arm.

10. A ramp assembly for a bicycle carrier, the bicycle carrier having a wheel securement arm and a wheel platform; the ramp assembly comprising:
a first bracket configured to attach to the wheel securement arm;
a first ramp tab pivotally attached to the first bracket by a hinge and configured to pivot from a stowed position to a deployed position;
wherein in the deployed position the first ramp tab is configured to provide a ramp for a bicycle to roll onto the wheel platform.

11. The ramp assembly of claim 10 wherein the first bracket receives a side member of the wheel securement arm.

12. The ramp assembly of claim 11 wherein the first bracket comprises a first side wall, and end wall, and a second side wall that define a cavity for receiving the side arm member.

13. The ramp assembly of claim 12 further comprising a flange disposed on an inner surface of the first side wall for retaining the side arm member in the cavity of the ramp assembly.

14. The ramp assembly of claim 10 wherein the wheel securement arm comprises a side arm member, and the side arm member comprises a feature for receiving the ramp bracket.

15. The ramp assembly of claim 14 wherein the feature comprises a t-channel.
